(19) United States
(12) Patent Application Publication
(10) Pub. No.: US 2020/0394571 A1
(43) Pub. Date: Dec. 17, 2020

(54) INFORMATION PROCESSING SYSTEM AND NON-TRANSITORY COMPUTER READABLE MEDIUM STORING PROGRAM

(71) Applicant: FUJI XEROX CO., LTD., Tokyo (JP)

(72) Inventor: Kengo TOKUCHI, Kanagawa (JP)

(73) Assignee: FUJI XEROX CO., LTD., Tokyo (JP)

(21) Appl. No.: 16/654,260

(22) Filed: Oct. 16, 2019

(30) Foreign Application Priority Data
Jun. 17, 2019 (JP) 2019-112200

(51) Int. Cl. G06Q 10/02; G07C 9/00

(52) U.S. Cl. CPC G06Q 10/02; G07C 9/00039

(57) ABSTRACT

An information processing system includes an acquisition unit that acquires environmental information for a place registered in a reservation making system, the environment information being related to a time frame specified by a user, and an output unit that outputs the environmental information acquired by the acquisition unit.

### CROSS-REFERENCE TO RELATED APPLICATIONS

This application is based on and claims priority under 35 USC 119 from Japanese Patent Application No. 2019-112200 filed Jun. 17, 2019.

### BACKGROUND

### (i) Technical Field

The present disclosure relates to an information processing system and a non-transitory computer readable medium storing a program.

### (ii) Related Art

For example, Japanese Unexamined Patent Application Publication No. 2004-86582 discloses a rental booth that provides a space available to a user for a predetermined period. The rental booth includes a user authentication unit, an electric lock for management of entry to and exit from the space, and a computer terminal to be used by the user. The computer terminal has a function of providing a service for the user and accepting a request from the user.

### SUMMARY

Aspects of non-limiting embodiments of the present disclosure relate to the following circumstances. When a user uses a place by making a reservation, the user's work efficiency may decrease depending on an environment of the place.

It is desirable that information on the environment for requested time frame of the reservation may be grasped for the place that the user wants to reserve.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system comprising an acquisition unit that acquires environmental information for a place registered in a reservation making system, the environment information being related to a time frame specified by a user, and an output unit that outputs the environmental information acquired by the acquisition unit.

### BRIEF DESCRIPTION OF THE DRAWINGS

An exemplary embodiment of the present disclosure will be described in detail based on the following figures, wherein:

FIG. 1 schematically illustrates an example of the overall configuration of an information processing system according to an exemplary embodiment;

FIG. 2 illustrates an example of the external structure of a booth type space;

FIG. 3 illustrates an example of the configuration of the space according to the exemplary embodiment;

FIG. 4 illustrates an example of the hardware configuration of a space management server according to the exemplary embodiment;

FIG. 5 illustrates an example of the hardware configuration of a user terminal according to the exemplary embodiment;

FIG. 6 illustrates an example of the functional configuration of the space management server;

FIG. 7 is a flowchart illustrating an example of a procedure of processing of grasping environmental information;

FIG. 8 is a flowchart illustrating an example of a procedure of processing of outputting the environmental information;

FIG. 9 illustrates an example of a reservation screen to be displayed on a display device of the user terminal;

FIG. 10 illustrates an example of environmental information to be displayed on the display device of the user terminal;

FIG. 11 illustrates another example of the reservation screen;

FIG. 12 illustrates another example of the reservation screen;

FIG. 13 illustrates an example of a screen showing information on other spaces around a space specified by a user;

FIG. 14 illustrates an example of a notification of a change in environmental information for a space reserved by the user;

FIG. 15 illustrates an example of a notification of another space that is an alternative candidate for the space reserved by the user;

FIG. 16 illustrates an example of a notification of another time frame that is an alternative candidate for the time frame that has been reserved by the reservation made by the user;

FIG. 17 is a flowchart illustrating an example of a procedure of processing of reserving a space based on environmental information;

FIG. 18 illustrates an example of processing of selecting a space in accordance with a rule that is based on a purpose of use; and

FIG. 19 illustrates an example of a screen showing information on the space selected based on the environmental information.

### DETAILED DESCRIPTION

An exemplary embodiment of the present disclosure is described below with reference to the drawings.

### <Overall Configuration of Information Processing System>

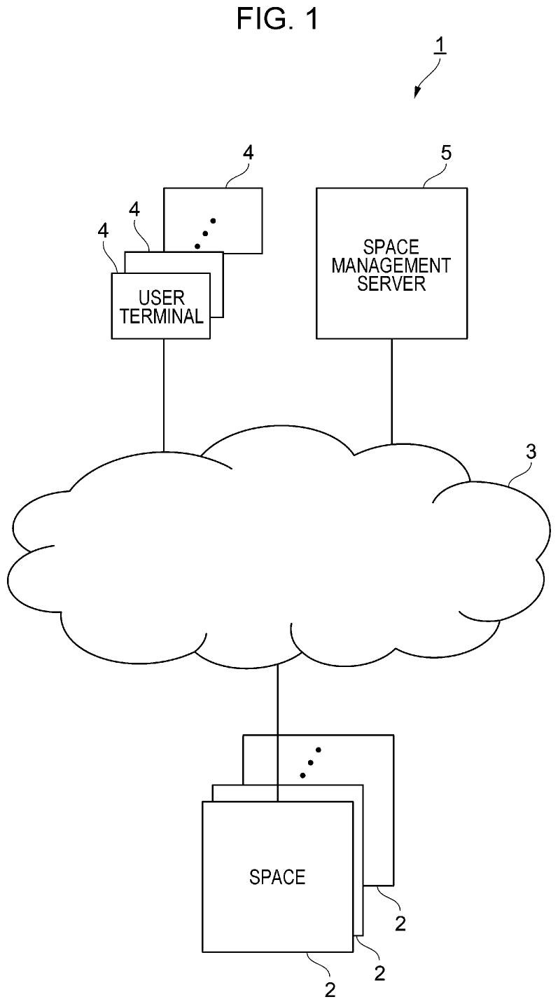

FIG. 1 schematically illustrates an example of the overall configuration of an information processing system 1 according to this exemplary embodiment. The information processing system 1 according to this exemplary embodiment includes various apparatuses and spaces 2 connected to a cloud network 3.

The spaces 2 include a booth, a room of an accommodation or the like, and a conference room of a company or the like. The spaces 2 may be movable places such as an automobile. Those spaces are examples of a space demarcated from surroundings with walls, partitions, or the like. The spaces 2 include a table and a seat in a restaurant or the like where a service is provided. Those spaces are examples of a space open to surroundings. Thus, the space 2 of this exemplary embodiment only needs to be a place available to a user and the type of the place is not limited.

The space 2 of this exemplary embodiment is assigned a name, a number, or the like for management. Reservation of the space 2 may be chargeable or free of charge.

If an electronic lock is attached to a door of the space 2, the space 2 is available under a condition that the user has an electronic key provided in advance. If the space 2 has no door, the space 2 is available, for example, under a condition that the user is authenticated by using an authentication code provided in advance or a manager of the space 2 verifies the name of the user who uses the space 2.

When the user reserves the space 2, the user who will use the space 2 may make the reservation or another user may make the reservation on behalf of the user who will use the space 2.

In this exemplary embodiment, a plurality of spaces 2 are provided as examples of the place for reservation.

As examples of the apparatuses connected to the cloud network 3, FIG. 1 illustrates user terminals 4 operated by users, and a space management server 5 that manages the spaces 2.

In the case of FIG. 1, one server is prepared as the space management server 5. A plurality of servers may be prepared to implement functions of the space management server 5.

The number of business entities that manage a certain space 2 may be one or plural. For example, different business entities may individually have responsibilities for management of reservations, management of entry/exit and usage of rooms, management of charges for use on users, and management of members registered as users.

As described above, the spaces 2 to be managed for reservation need not be the same type of space. For example, a subset of the spaces 2 may be booths and another subset of the spaces 2 may be a seat and a table in a restaurant or the like.

A plurality of business entities may offer management of one purpose or function in cooperation.

The user terminal 4 is an apparatus to be used by a user. In this exemplary embodiment, the user terminal 4 is assumed to be a smartphone to be carried by a user. The user terminal 4 may be a so-called wearable terminal, a notebook computer, or a game console.

The space management server 5 manages various types of information related to spaces 2.

For example, a user inputs information and communicates with the space management server 5 by causing the user terminal 4 to start an application or groupware to be used for reservation of the space 2. Thus, various types of information related to a reservation of the space 2 are stored in the space management server 5.

Specifically, examples of various types of information related to a reservation of the space 2 include information on a reserving person of the space 2, information on the space 2, a start point of a time frame reserved by the reservation, and an end point of the time frame reserved by the reservation. Examples of the information on a reserving person of the space 2 include a name, sex, and age, an organization (e.g., a company), an employee's ID, an account, a password, and any information assigned to manage this person. If another user makes a reservation on behalf of a user who will use the space 2, information on the reserving person and information on the user who will actually use the space 2 may be stored. Examples of the information on the space 2 include information for identifying an address or a location of the space 2, a management name, and a management number.

Although details are described later, the space management server 5 grasps information on an environment related to each space 2 (the information on the environment is hereinafter referred to as “environmental information”) by using various types of information. For example, the space management server 5 outputs, to a user terminal 4 of a user who wants to make a reservation, environmental information related to a space 2 and a time frame that the user wants to reserve by a reservation. The user may reserve the space 2 after checking the environmental information. The time frame may be specified by the time, date, week, month, etc. or a combination thereof.

The space management server 5 may manage reservation of an article or service associated with the space 2. For example, the space management server 5 may manage a lendable or licensable article or service or a consumable article or service.

### <Structure of Space>

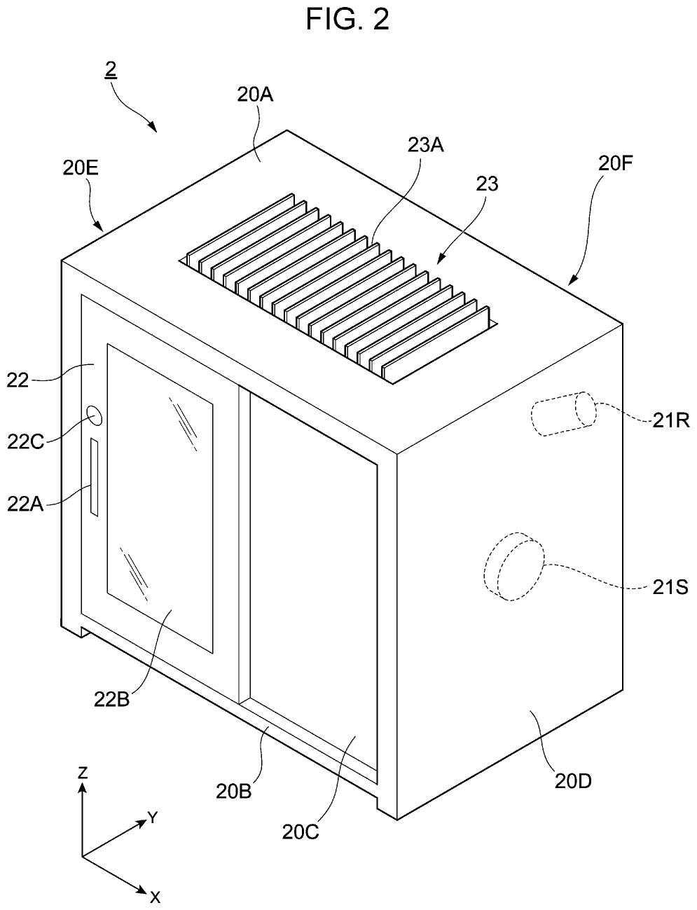

FIG. 2 illustrates an example of the external structure of a booth type space 2.

The booth type space 2 illustrated in FIG. 2 is arranged irrespective of indoors or outdoors. For example, the booth type space 2 is arranged in a station yard, an airport, an office building, a commercial facility such as a restaurant or a department store, a bank, a library, an art gallery, a museum, a public institution or facility, an accessway, or a park.

The booth type space 2 illustrated in FIG. 2 is a closed booth having a ceiling. The term “closed” does not mean “sealed” and the closed booth only needs to have a practical sound-proof property. Therefore, an opening or clearance such as an air vent or a small window may be provided in a portion of a frame that defines the space 2. The window may be openable and closable.

The frame of the space 2 illustrated in FIG. 2 includes a ceiling 20A, a floor 20B, a wall 20C having an openable and closable door 22, two walls 20D and 20E located on both sides of the wall 20C, and a wall 20F located opposite the door 22.

In the case of FIG. 2, the ceiling 20A has a ventilating hole 23. A louver 23A capable of adjusting the opening area is attached to the ventilating hole 23. The louver 23A of FIG. 2 is fully open.

In this exemplary embodiment, the door 22 is assumed to be a sliding door movable along the wall 20C. In the case of FIG. 2, the door 22 is a single sliding door that slides in one direction. The door 22 may be a double sliding door to be opened or closed by moving two or more members in different directions, or a drawn door having two members slidable to right and left.

The door 22 is not limited to the sliding door. For example, the door 22 may be a single hinged door having one swingable member, or a double hinged door having one opening closed by two door members.

The door 22 may be a folding door to be opened by folding a pair of door members coupled by hinges. The folding door may be a folding door of a type in which door members are opened in one direction, or in which door members are opened in two directions.

As a special type of door, the door 22 may be a partition door or a retractable sliding door to be retracted into a wall when the door 22 is opened.

The door 22 may be opened inward or outward.

In the case of FIG. 2, the door 22 has a handle 22A to be gripped by a user when the door 22 is opened or closed.

A member 22B subjected to treatment in consideration of confidentiality and security is arranged at the center of the door 22. For example, the member 22B may be a transparent plate in which a metal plate having many arrays of holes (for example, a perforated metal) is attached on an inner side, a transparent plate in which a screen member is attached on an inner side with a clearance, a transparent plate having a film that makes it easy to view the inside from the front but difficult to view the inside in a slanting direction, or a transparent plate subjected to treatment for reducing internal visibility.

For example, glass or an acrylic resin is used for the transparent plate. A characteristic related to the transparency of the film bonded for confidentiality and security is determined based on a relationship between the position of the door 22 and the working position of the user. If the user works on a far side behind the front of the door 22, it is appropriate to use a film that makes it difficult to view the inside from the front but easy to view the inside in a slanting direction.

The film may be a liquid crystal film whose transparent state and opaque state are switchable electrically, or a polarizing film whose transmittance is controllable electrically.

Examples of the treatment for reducing visibility include finely scoring the surface of the member so that light is scattered.

The treatment may be performed on a portion of the member 22B. For example, the structure may be provided such that the member 22B is transparent near the floor and the ceiling and the visibility is reduced through the treatment in a range in which a monitor may be viewed during work.

By arranging the member 22B, the presence or absence of the user may be confirmed from the outside while hiding a screen of the monitor from the outside.

An electronic lock 22C unlockable with an electronic key is attached to the door 22.

The treatment in consideration of confidentiality and security may be performed on a member other than the door 22. For example, the treatment in consideration of confidentiality and security may be performed on at least a portion of the wall 20D, 20E, or 20F.

The number of users of the space 2 is roughly determined depending on the volume of the space 2. The space 2 illustrated in FIG. 2 is assumed to be a private room that is basically used alone. The space 2 according to this exemplary embodiment may be used by a few people such as two or three people. The space 2 according to this exemplary embodiment may be a large room capable of accommodating many people. The large room may be formed as a single room but may be formed by removing one or both of the walls 20D and 20E of the space 2 and coupling a plurality of spaces 2.

The shape and structure of the frame that defines the space 2 and the provided equipment and performance thereof are arbitrary. For example, the ceiling 20A may be omitted.

In this exemplary embodiment, one desk and one chair (not illustrated) are arranged in the frame. Furnished equipment and devices or reserved equipment and devices are arranged on the desk.

A photographing apparatus 21R such as a camera that photographs the inside of the frame and a motion sensor 21S that detects a user in the frame are provided in the frame.

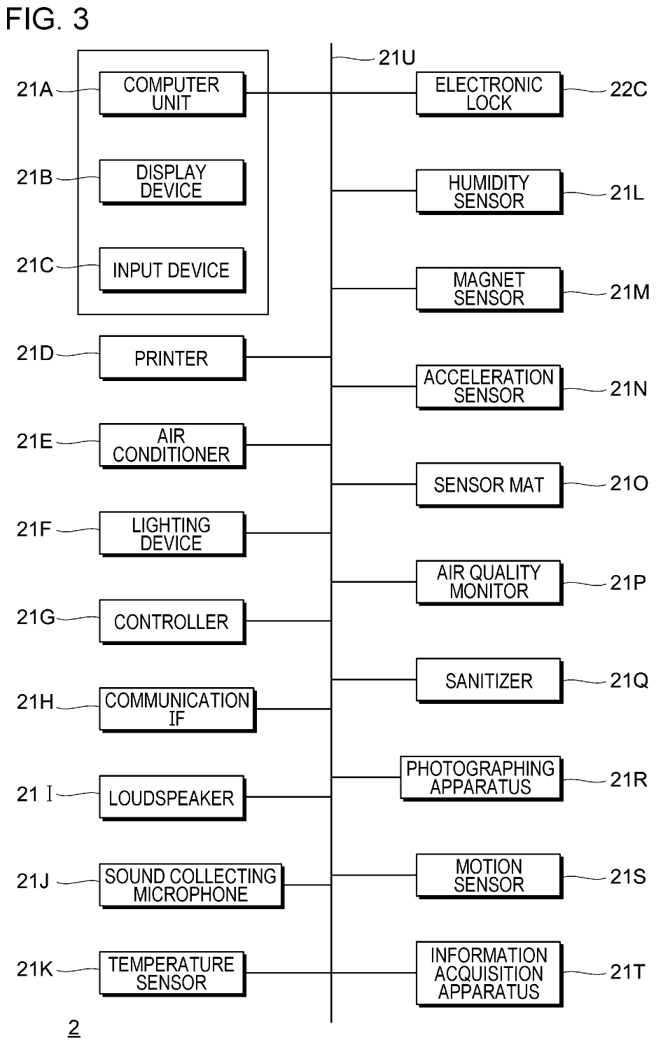

FIG. 3 illustrates an example of the configuration of the space 2 according to this exemplary embodiment.

The space 2 includes a computer unit 21A, a display device 21B, an input device 21C, a printer 21D, an air conditioner 21E, a lighting device 21F, and a controller 21G.

The computer unit 21A, the display device 21B, and the input device 21C are information devices prepared in the room in advance for user's operations. Those devices are connected through a local area network (LAN) 21U (for example, a LAN cable or a wireless LAN). If the user brings a computer into the room, the computer brought into the room is connected to the LAN 21U. Examples of the wireless LAN include Wi-Fi (registered trademark) and Bluetooth (registered trademark).

The printer 21D is prepared in the room in advance for user's operations and executes a printing function, a scanning function, and the like through the user's operations.

The air conditioner 21E is used for adjusting a temperature and a humidity in the room. A ventilator that specializes in ventilation may be provided together with or separately from the air conditioner 21E. The ventilator includes an air supply system that supplies fresh air into the room, and an air vent system that vents the indoor air to the outside. For example, the ventilating hole 23 (see FIG. 2) and the louver 23A (see FIG. 2) constitute the ventilator.

The lighting device 21F illuminates the room.

The controller 21G is a control computer that collects pieces of information from the devices connected to the LAN 21U and controls operations of the individual devices. Depending on the information processing system 1, the controller 21G may function as the space management server 5.

A communication interface (communication IF) 21H is prepared in the space 2 for external communication. The communication IF 21H is connected to the cloud network 3 (see FIG. 1) for use in communication with various apparatuses.

A loudspeaker 211 is prepared in the space 2. The loudspeaker 211 is used for reporting information to a user in the room or a person outside the room.

A sound collecting microphone 21J is prepared in the space 2. The sound collecting microphone 21J is used for collecting sound in the room. A sound collecting microphone 21J to be used for collecting sound outside the room may be provided separately from the sound collecting microphone 21J in the room.

A temperature sensor 21K is prepared in the space 2. The temperature sensor 21K is used for measuring a temperature in the room. A temperature sensor 21K to be used for measuring a temperature outside the room may be provided separately from the temperature sensor 21K in the room.

A humidity sensor 21L is prepared in the space 2. The humidity sensor 21L is used for measuring a humidity in the room. A humidity sensor 21L to be used for measuring a humidity outside the room may be provided separately from the humidity sensor 21L in the room.

A magnet sensor 21M is prepared in the space 2. The magnet sensor 21M is attached to the door 22 to detect that the door 22 is opened or closed through detection of a magnetic force.

An acceleration sensor 21N is prepared in the space 2. The acceleration sensor 21N is used for detecting motion of an object.

A sensor mat 21O is prepared in the space 2. The sensor mat 21O is used for detecting the weight of an object to visualize a duration of a person's stay or congestion.

An air quality monitor 21P is prepared in the space 2. The air quality monitor 21P is a sensor that detects components contained in indoor air. For example, the air quality monitor 21P measures an odor, the concentration of PM 2.5 or PM 10, the concentration of carbon dioxide, a temperature, a humidity, and the concentration of a volatile organic compound. The air quality monitor 21P need not measure all the components described above and may measure other components. If the air quality monitor 21P may measure the temperature and the humidity, the temperature sensor 21K and the humidity sensor 21L need not be provided separately.

A sanitizer 21Q is prepared in the space 2. The sanitizer 21Q is prepared to sanitize the room. Examples of the sanitizer 21Q of this exemplary embodiment include a light source that generates light having an ultraviolet wavelength (hereinafter referred to as “ultraviolet light source”), and an atomizer that atomizes and sprays a deodorant.

Examples of the ultraviolet light source include an ultraviolet light emitting diode (LED). In this exemplary embodiment, the light source that generates light having an ultraviolet wavelength is turned ON only when a person is not in the room but is turned OFF when a person is in the room.

In this exemplary embodiment, both the ultraviolet light source and the deodorant atomizer are arranged as the sanitizer 21Q but the ultraviolet light source or the deodorant atomizer may be arranged alone.

For example, the photographing apparatus 21R is a camera that photographs the inside of the room.

The motion sensor 21S is used for detecting a person in the room and various types of sensor exist. Examples thereof include a pyroelectric infrared motion sensor capable of detecting motion of a person, a video motion sensor capable of detecting the number of persons and their positions, and a thermopile motion sensor. Depending on purposes, one of the sensors is used alone or a plurality of sensors are used in combination.

An information acquisition apparatus 21T is attached to an outer side of the space 2, such as the door 22. The information acquisition apparatus 21T acquires information on each user of the space 2. For example, the information acquisition apparatus 21T is a reader that reads an ID card held over the reader by a user. For example, the information acquisition apparatus 21T may be a reader that reads a fingerprint or a vein pattern of a user.

The electronic lock 22C is unlocked with the electronic key. After the electronic lock 22C is unlocked, the door 22 may be opened or closed and a user may enter the space 2.

### <Hardware Configurations of Apparatuses>

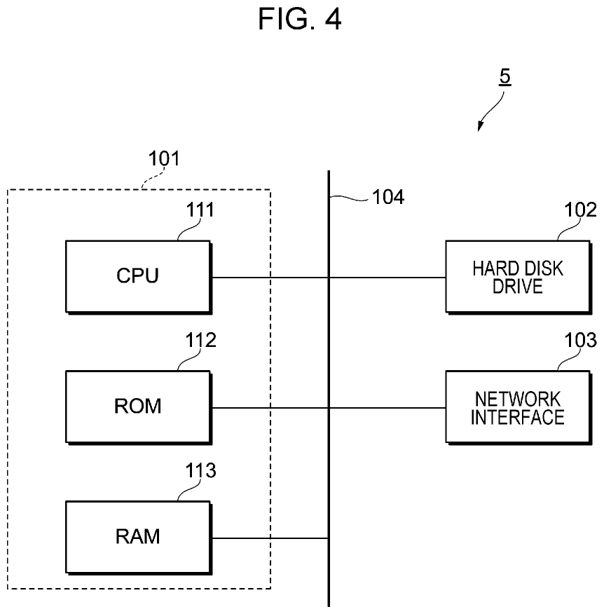

FIG. 4 illustrates an example of the hardware configuration of the space management server 5 according to this exemplary embodiment.

The space management server 5 includes a control unit 101 that controls an overall operation of the apparatus, a hard disk drive 102 that stores management data and the like, and a network interface 103 that achieves communication via a local area network (LAN) cable or the like.

The control unit 101 includes a central processing unit (CPU) 111, a read only memory (ROM) 112 that stores basic software, a basic input/output system (BIOS), and the like, and a random access memory (RAM) 113 to be used as a working area. The CPU 111 may be a multi-core CPU. The ROM 112 may be a rewritable non-volatile semiconductor memory. The control unit 101 is a so-called computer.

The hard disk drive 102 is an apparatus that reads and writes data on a non-volatile storage medium obtained by applying a magnetic substance to the surface of a disc-shaped substrate. The non-volatile storage medium may be a semiconductor memory or a magnetic tape.

As necessary, the space management server 5 includes an input device such as a keyboard and a mouse, and a display device such as a liquid crystal display.

The control unit 101, the hard disk drive 102, and the network interface 103 are connected through a bus 104 and signal lines (not illustrated).

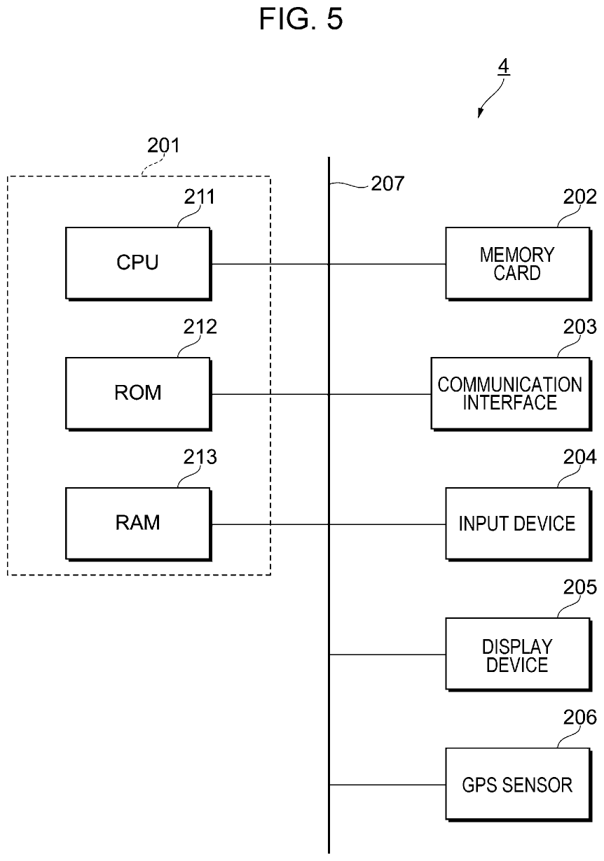

FIG. 5 illustrates an example of the hardware configuration of the user terminal 4 according to this exemplary embodiment. The configuration illustrated in FIG. 5 is assumed to be a configuration when the user terminal 4 is a smartphone.

The user terminal 4 includes a control unit 201 that controls an overall operation of the apparatus, a memory card 202 that stores various types of data, various types of communication interface 203 conforming to wireless communication standards, an input device 204 such as a touch sensor, a display device 205 such as a liquid crystal display or an organic electroluminescence (EL) display, a Global Positioning System (GPS) sensor 206, and a bus 207 that connects the respective parts.

The control unit 201 includes a CPU 211, a ROM 212 that stores firmware, a BIOS, and the like, and a RAM 213 to be used as a working area. The CPU 211 may be a multi-core CPU. The ROM 212 may be a rewritable non-volatile semiconductor memory.

For example, the communication interface 203 is an interface to be used for connection to the space management server 5, or an interface to be used for connection to a wireless LAN.

The GPS sensor 206 measures the position of the user terminal 4 by receiving an electric wave from a GPS satellite. Information on a latitude, a longitude, and an altitude output from the GPS sensor 206 provides a current position of the user terminal 4. The GPS sensor 206 may be compatible with an indoor positioning system.

### <Functional Configuration of Space Management Server>

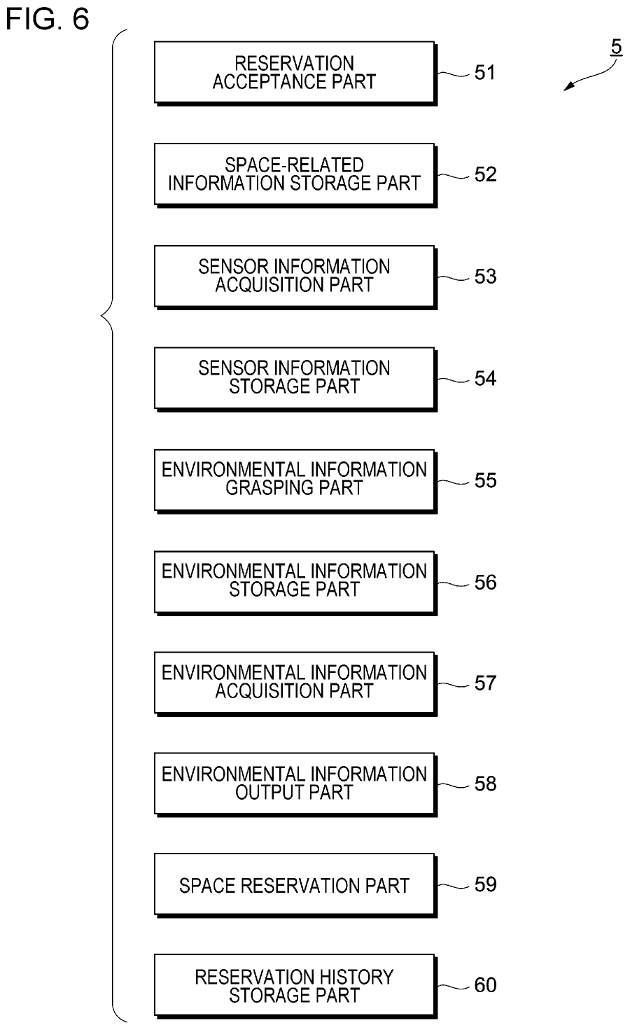

FIG. 6 illustrates an example of the functional configuration of the space management server 5. The space management server 5 includes a reservation acceptance part 51, a space-related information storage part 52, a sensor information acquisition part 53, a sensor information storage part 54, an environmental information grasping part 55, an environmental information storage part 56, an environmental information acquisition part 57, an environmental information output part 58, a space reservation part 59, and a reservation history storage part 60.

For example, the reservation acceptance part 51 accepts a reservation for the spaces 2 that is made by a user through his/her user terminal 4. Specifically, when the user accesses the space management server 5 by using the user terminal 4, the display device 205 of the user terminal 4 displays a screen showing a web page that accepts details of a reservation that the user wants to make for any of the spaces 2 (hereinafter referred to as “reservation screen”). The user may input conditions for the reservation on the reservation screen. Examples of the reservation conditions include, but are not limited to, a place condition and a time condition.

As a place condition, the user may provide a specific space 2 the user wants to reserve, a location of a specific place the user wants to reserve, a region (e.g., New York) or a building which the user is trying to find a place to reserve in, a station which the user is trying to find a place to reserve around, or other information similar to these examples.

As a time condition, the user may provide a time frame for which the user actually wants to reserve the space 2, or, if the user can be flexible, a time frame comprising a time frame for which the user may want to reserve the space 2. A time frame can be specified in various ways. For example, the user may provide: a particular hour, date, week, month, or a year; a start point and an end point; a start point and a duration (e.g., an hour from 11:30); an expected arrival date and the number of nights the user wants to reserve; AM (ante meridiem) or PM (post meridiem); or other information similar to these examples. In a case where, for example, the reservation system has a predetermined duration that can be reserved, the time frame may be specified by having the user provide just a start point or an end point. Below, a time frame specified by a start date and time and an end date and time is mainly used as an example, but it should be noted that this is just an example.

The reservation conditions may also include a condition on equipment the user wants to use in the space 2, the size of the space 2, and environmental information.

The space 2 and the time frame that the user wants to reserve date and time are identified based on the reservation conditions. In one embodiment, the user may provide information about a place from which he/she wants to find a space 2 and a time frame for which the user wants to reserve the space 2. When the user inputs these reservation conditions, spaces 2 that satisfy the reservation conditions are retrieved. When the user specifies a particular space 2 he/she wants to reserve, a reservation of the space 2 for the time frame is made, and information about the reservation is registered.

The space-related information storage part 52 stores various types of information related to the function and performance of the space 2. Examples of various types of information related to the function and performance of the space 2 include pieces of information on equipment available in the space 2, the size of the space 2, a material for walls, the presence or absence of windows, and the number of windows. Further, the information may include not only the information on each space 2 but also information on a plurality of spaces 2, such as the density of the spaces 2 or distances to other spaces 2 on the periphery. For example, those pieces of information are stored through settings made by an administrator of the information processing system 1 or managers of the spaces 2.

For example, the sensor information acquisition part 53 acquires pieces of information collected by various sensors installed in each space 2 (for example, the sound collecting microphone 21J, the temperature sensor 21K, the humidity sensor 21L, and the air quality monitor 21P) through communication with the space 2. The sensor information acquisition part 53 stores the acquired pieces of information in the sensor information storage part 54.

The sensor information acquisition part 53 stores, in the sensor information storage part 54, pieces of information collected by various sensors while the user is using the space 2 and stores those pieces of information in the reservation history storage part 60 as pieces of information related to the user's reservation.

The sensor information storage part 54 stores pieces of information acquired by the sensor information acquisition part 53 (that is, pieces of information collected by various sensors).

The environmental information grasping part 55 grasps environmental information related to each space 2. Specifically, the environmental information grasping part 55 may grasp environmental information related to a particular time.

Examples of the environmental information include sound information of the space 2, odor information of the space 2, sunlight/illuminance information of the space 2, temperature information of the space 2, and humidity information of the space 2. Thus, the environmental information is classified into a plurality of types. The environmental information grasping part 55 grasps the environmental information for each space 2 by using various types of information.

Examples of various types of information include a reservation history of the space 2, information related to the function and performance of the space 2, and pieces of information collected in the space 2 by various sensors.

For example, the reservation history of the space 2 is at least one of a reservation history of a space 2 whose environmental information is grasped (hereinafter referred to as “grasping target space”) or a reservation history of another space 2 around the grasping target space (hereinafter referred to as “peripheral space”).

For example, the information related to the function and performance of the space 2 is at least one of information related to the function and performance of the grasping target space or information related to the function and performance of the peripheral space.

The pieces of information collected in the space 2 by various sensors are at least one of pieces of information collected in the grasping target space by various sensors or pieces of information collected in the peripheral space by various sensors. The pieces of sensor information include information collected in the space 2 and information collected outside the space 2.

For example, the grasping target space is a space 2 that a user wants to reserve. For example, the peripheral space is a space 2 at the same location as that of the grasping target space, or a space 2 within a predetermined range from the grasping target space (for example, a range of 10 meters from the grasping target space).

The environmental information storage part 56 stores environmental information related to each space 2, which is grasped by the environmental information grasping part 55.

The environmental information acquisition part 57, an example of an acquisition unit, acquires, from the environmental information storage part 56, environmental information for a space 2 that relates to a time frame a user wants to reserve. For example, when the user inputs a space 2 that the user wants to reserve and a time frame the user wants to reserve on the reservation screen, the environmental information acquisition part 57 acquires, from the environmental information storage part 56, environmental information related to the input space 2 and any moments in the input time frame.

The environmental information output part 58, an example of an output unit, outputs the environmental information acquired by the environmental information acquisition part 57. For example, the output environmental information is transmitted to the user terminal 4 of the user who wants to reserve the space 2 and is displayed on the display device 205 of the user terminal 4. The user may specify and reserve the requested space 2 after checking the displayed environmental information.

When the user gives an instruction to reserve the space 2, the space reservation part 59 reserves the space 2 specified by the user for the time frame specified by the user.

The reservation history storage part 60 stores various types of information related to reservations made by the space reservation part 59.

The reservation history storage part 60 stores information indicating usage of the space 2 that is used by each user. As described above, examples of the information indicating usage include pieces of information collected by various sensors while the user is using the space 2. The information may manually be input by the manager of the space 2. For example, the information is used by the environmental information grasping part 55 to grasp environmental information or is presented for reference to the user who wants to reserve the space 2.

The functional parts of the space management server 5 are implemented in cooperation between a software resource and a hardware resource. Specifically, if the space management server 5 is implemented by the hardware configuration illustrated in FIG. 4, the functional parts such as the reservation acceptance part 51, the sensor information acquisition part 53, the environmental information grasping part 55, the environmental information acquisition part 57, the environmental information output part 58, and the space reservation part 59 are implemented such that a program stored in the hard disk drive 102 is read on the RAM 113 and executed by the CPU 111. For example, the space-related information storage part 52, the sensor information storage part 54, the environmental information storage part 56, and the reservation history storage part 60 are implemented by the hard disk drive 102.

### <Processing to be Performed by Space Management Server>

Next, description is made of procedures of processing to be performed by the space management server 5. Each processing step may hereinafter be represented by a symbol “S”.

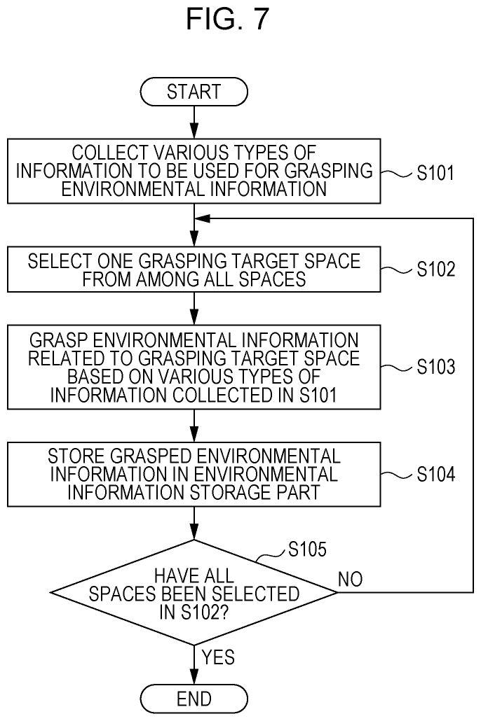

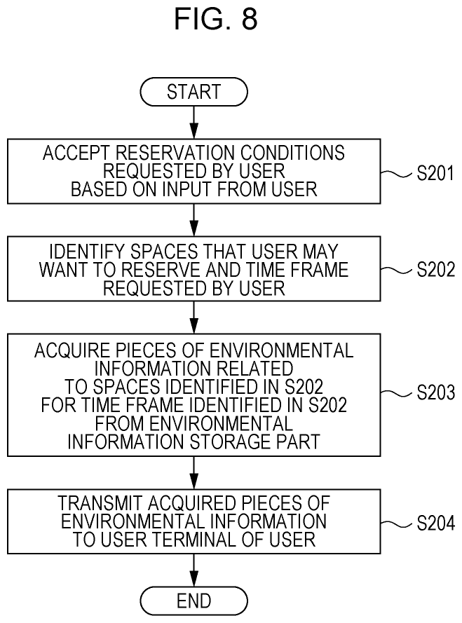

FIG. 7 is a flowchart illustrating an example of a procedure of processing of grasping environmental information. FIG. 8 is a flowchart illustrating an example of a procedure of processing of outputting the environmental information.

First, the procedure of the processing of grasping environmental information is described with reference to FIG. 7. For example, the processing illustrated in FIG. 7 is performed at every predetermined timing such as every one minute. For example, the processing may be performed at every timing when a user reserves a space 2.

The environmental information grasping part 55 collects various types of information to be used for grasping environmental information (S101). The environmental information grasping part 55 collects pieces of information stored in the reservation history storage part 60, information stored in the space-related information storage part 52, and information stored in the sensor information storage part 54 for all the spaces 2.

Next, the environmental information grasping part 55 selects one space 2 whose environmental information is grasped (that is, a grasping target space) from among all the spaces 2 (S102).

Next, the environmental information grasping part 55 grasps environmental information related to the grasping target space based on various types of information collected in S101 (S103). For example, the environmental information grasping part 55 grasps environmental information during a predetermined period from a present time point. Examples of the predetermined period include one week and one month. More specifically, if the space 2 may be reserved up to one month ahead from the present time point on the reservation system, the environmental information grasping part 55 grasps environmental information during a period up to one month ahead from the present time point. The environmental information grasping part 55 grasps environmental information for finer time segments in the predetermined period. Examples of the time segment include 10 minutes and 30 minutes, which are segments of time during which the space 2 may be reserved.

Next, the environmental information grasping part 55 stores the grasped environmental information in the environmental information storage part 56 (S104). Next, the environmental information grasping part 55 determines whether all the spaces 2 have been selected in S102 (S105). When the result of determination in S105 is positive (YES), the processing flow is terminated. When the result of determination in S105 is negative (NO), the processing proceeds to S102 and pieces of environmental information related to the remaining spaces 2 are grasped subsequently.

Next, the procedure of the processing of outputting the environmental information is described with reference to FIG. 8. For example, the processing illustrated in FIG. 8 is performed at a timing when the user accesses the space management server 5 by using the user terminal 4 to input reservation conditions on the reservation screen. In this example, a state in which the reservation screen is displayed on the display device 205 of the user terminal 4 is described as an initial state.

When the reservation screen is displayed, the reservation acceptance part 51 accepts the reservation conditions requested by the user based on the input from the user (S201). Next, the environmental information acquisition part 57 identifies, based on the accepted reservation conditions, spaces 2 that the user may want to reserve and a time frame requested by the user (S202).

Next, the environmental information acquisition part 57 acquires, from the environmental information storage part 56, pieces of environmental information related to the spaces 2 identified in S202 for the time frame identified in S202 (S203). Next, the environmental information output part 58 transmits the acquired pieces of environmental information to the user terminal 4 of the user (S204). Then, the processing flow is terminated.

### <Specific Examples of Processing of Grasping Environmental Information>

Next, the processing of grasping environmental information is described taking specific examples. In the following examples, sound information of the space 2, odor information of the space 2, and illuminance information of the space 2 are described as examples of the environmental information.

Temperature information of the space 2, humidity information of the space 2, and other environmental information may be grasped through processing similar to that of the following examples.

### (Sound Information of Space 2)

The environmental information grasping part 55 grasps sound information of the grasping target space based on various types of information for grasping the environmental information.

For example, the environmental information grasping part 55 grasps the sound information of the grasping target space based on a reservation history of one or more peripheral spaces. If the reservation history indicates that one or more peripheral spaces are going to be used at a time the grasping target space is going to be used, sounds that are made in the one or more peripheral spaces may be heard by those using the grasping target space at the same time. Therefore, the environmental information grasping part 55 regards that a sound level in the grasping target space is expected to be higher during a time frame in which one or more peripheral spaces are reserved than during a time frame in which no or fewer peripheral spaces are reserved.

Influence of the sounds in each peripheral space that may be audible from the grasping target space may be made common to the peripheral spaces or varied depending on the peripheral spaces.

For example, the distance between the grasping target space and the peripheral space may be taken into consideration. Specifically, it is presumed that the influence of the sound in the peripheral space increases as the distance between the grasping target space and the peripheral space decreases. For example, if reservations are made for a peripheral space adjacent to the grasping target space and a peripheral space 10 meters away from the grasping target space, it is presumed, as a result of comparison between the two peripheral spaces, that influence of sounds in the peripheral space adjacent to the grasping target space is greater than influence of sounds in the peripheral space 10 meters away from the grasping target space.

For another example, information from a sensor installed in the peripheral space may be taken into consideration. Specifically, the sound level in each peripheral space may be grasped by averaging sounds obtained based on indoor sound information collected during a predetermined period by the sound collecting microphone 21J installed in the peripheral space.

If the reservation history indicates that a peripheral space has been reserved, the purpose of use of the peripheral space may be taken into consideration. For example, if the peripheral space is used for the purpose of business talk, there is a strong possibility that voice in the business talk is audible in the grasping target space. For example, if the peripheral space is used for the purpose of reading books, it is presumed that the level of sound audible in the grasping target space is lower than in the case of business talk. In this manner, the environmental information grasping part 55 may grasp the sound information of the grasping target space based on the purpose of use of the reserved peripheral space. Business talk is an example of a purpose of use that involves sound. Reading books is an example of a purpose of use that does not involve sound. The purpose of use of the peripheral space may be input by a user and stored in the reservation history storage part 60 when the user makes a reservation for the peripheral space.

If the reservation history indicates that the peripheral space has been reserved, a previous usage of any space 2 by a user who is going to use the peripheral space may be taken into consideration. For example, the environmental information grasping part 55 regards that a sound level in the grasping target space increases as a sound level in the space 2 observed during the previous usage of the space 2 by the user increases. The previous usage of the space 2 by the user who is going to use the peripheral space was collected by the sound collecting microphone 21J while the user was using the space 2 is stored in the reservation history storage part 60.

Information related to the function and performance of the grasping target space may be taken into consideration.

For example, equipment for the grasping target space may be taken into consideration. Specifically, if sound-proof equipment such as sound-proof walls is installed in the grasping target space, it is grasped that the sound level in the grasping target space is lower than in a case in which the sound-proof equipment is not installed. The performance may vary depending on the type of sound-proof equipment. Therefore, the sound information of the grasping target space may be varied depending on the performance of the sound-proof equipment. It is grasped that the sound level in the grasping target space decreases as the thicknesses of the walls of the grasping target space increase.

For example, the size of the grasping target space may be taken into consideration. Specifically, it is grasped that the influence of the sound in the peripheral space that is audible in the grasping target space decreases and the sound level in the grasping target space decreases as the size of the grasping target space increases.

Similarly, information related to the function and performance of the peripheral space may be taken into consideration.

For example, equipment for the peripheral space may be taken into consideration. Specifically, if sound-proof equipment is installed in the peripheral space, it is grasped that the sound level in the grasping target space is lower than in a case in which the sound-proof equipment is not installed. The sound information of the grasping target space may be varied depending on the performance of the sound-proof equipment. For example, it is grasped that the sound level in the grasping target space decreases as the thicknesses of the walls of the peripheral space increase. For example, if a sound system for movies is installed in the peripheral space, it is grasped that the sound level in the grasping target space is higher than in a case in which the sound system is not installed.

For example, the size of the peripheral space may be taken into consideration. Specifically, it is grasped that the influence of the sound in the peripheral space that is audible in the grasping target space decreases and the sound level in the grasping target space decreases as the size of the peripheral space increases.

For example, information from a sensor installed in the grasping target space may be taken into consideration. Specifically, a change in indoor sound over time is grasped based on indoor sound information collected by the sound collecting microphone 21J installed in the grasping target space. For example, a change in outdoor sound over time is grasped based on outdoor sound information collected by the sound collecting microphone 21J installed in the grasping target space. For example, the sound information of the grasping target space may be grasped depending on a time range or a day of week based on those pieces of information. For example, sound information of the grasping target space at the time immediately before a time frame requested by the user may be grasped based on information collected from the sensor at that time.

The environmental information grasping part 55 grasps the sound information of the grasping target space based on those pieces of information. Specifically, the environmental information grasping part 55 grasps the sound information of the grasping target space through addition to or subtraction from a reference sound level based on the pieces of information described above. The environmental information grasping part 55 grasps pieces of sound information of all the spaces 2 and stores the grasped pieces of sound information in the environmental information storage part 56.

The environmental information grasping part 55 only needs to use at least a portion of the pieces of information described above. For example, the environmental information grasping part 55 may grasp the sound information of the grasping target space by using the pieces of information on the equipment for the grasping target space and the equipment for the peripheral space instead of using the reservation history of the peripheral space.

### (Odor Information of Space 2)

The environmental information grasping part 55 grasps odor information of the grasping target space based on various types of information for grasping the environmental information.

For example, the environmental information grasping part 55 grasps the odor information of the grasping target space based on a reservation history of the grasping target space. If the grasping target space is used, it is presumed that an odor is generated in the grasping target space by using the grasping target space. Therefore, the environmental information grasping part 55 grasps the odor information of the grasping target space by using information on an idle time from an end time of a reservation for the grasping target space to a start time of a subsequent reservation. Specifically, it is grasped that the odor level decreases as the idle time increases. For example, if the idle time between the time of a previous reservation and the time frame requested by a user is 10 hours, it is grasped that the odor level in the grasping target space is lower than in a case in which the idle time is 5 hours.

The information on the odor generated by using the grasping target space may be made common to individual uses of the grasping target space or varied depending on the individual uses.

For example, if the grasping target space is reserved, a purpose of use, details of use, and a reservation period for a user of the grasping target space may be taken into consideration. Specifically, if the user intends to eat and drink in the grasping target space, an odor of food is likely to remain. Therefore, the environmental information grasping part 55 presumes that the level of the odor to be generated in the grasping target space is higher in the case in which the user intends to eat and drink in the grasping target space than in a case in which the user does not intend to eat and drink. For example, if the user intends to smoke in the grasping target space, an odor of smoke is likely to remain. Therefore, the environmental information grasping part 55 presumes that the level of the odor to be generated in the grasping target space is higher in the case in which the user intends to smoke in the grasping target space than in a case in which the user does not intend to smoke. The environmental information grasping part 55 also presumes that the level of the odor generated in the grasping target space increases as the grasping target space is used for a longer period.

If the grasping target space is reserved, a previous usage of a space 2 for a user who is going to use the grasping target space by the reservation may be taken into consideration. For example, the environmental information grasping part 55 presumes information on an odor to be generated in the grasping target space based on odor information of the space 2 previously used by the user who is going to use the grasping target space. The previous usage of the space 2 for the user who is going to use the grasping target space is stored in the reservation history storage part 60. For example, if the user previously used any space 2, odor information was collected by the air quality monitor 21P and stored in the reservation history storage part 60 while the user was using the space 2.

Information related to the function and performance of the grasping target space may be taken into consideration.

For example, equipment for the grasping target space may be taken into consideration. Specifically, an odor to be eliminated during the idle time of the grasping target space is grasped based on the performance of the sanitizer 21Q installed in the grasping target space. For example, an odor to be vented during the idle time of the grasping target space may be grasped based on the performance of the ventilator.

For example, the size of the grasping target space may be taken into consideration. Specifically, it is grasped that the odor level in the grasping target space decreases as the size of the grasping target space increases.

For example, information from a sensor installed in the grasping target space may be taken into consideration. Specifically, the environmental information grasping part 55 grasps odor information at the start of a subsequent reservation based on a measurement value from the air quality monitor 21P installed in the grasping target space.

The environmental information grasping part 55 grasps the odor information of the grasping target space based on those pieces of information. The environmental information grasping part 55 grasps pieces of odor information of all the spaces 2 and stores the grasped pieces of odor information in the environmental information storage part 56.

Similarly to the case of grasping the sound information, the environmental information grasping part 55 only needs to use at least a portion of the pieces of information described above. For example, the environmental information grasping part 55 may grasp the odor information of the grasping target space by using the information on the equipment for the grasping target space instead of using the reservation history of the grasping target space.

### (Illuminance Information of Space 2)

The environmental information grasping part 55 grasps illuminance information of the grasping target space based on various types of information for grasping the environmental information.

For example, the environmental information grasping part 55 grasps the illuminance information of the grasping target space depending on the location of the grasping target space. Specifically, if the grasping target space is located outdoors, the direction of the sun is presumed based on time. The illuminance information is grasped based on the sunlight from that direction. For example, if the grasping target space is located indoors, the illuminance information is grasped based on the brightness of illumination in a room accommodating the grasping target space.

Information related to the function and performance of the grasping target space may be taken into consideration. For example, the presence or absence of windows in the grasping target space, the number of windows, and whether the windows are oriented to the sun may be taken into consideration. Specifically, if the grasping target space has windows, it is grasped that the sunlight is brighter and the illuminance is higher than in a case in which the grasping target space has no windows. For example, if the grasping target space is located at a corner, it is grasped that the sunlight is brighter and the illuminance is higher than in a case in which the grasping target space is not located at the corner. Further, the light blocking properties of the walls, the door 22, and the member 22B of the grasping target space may be taken into consideration.

The performance of the lighting device 21F of the grasping target space may be taken into consideration. For example, it is grasped that the illuminance in the grasping target space increases as the beam intensity of the lighting device 21F increases.

The environmental information grasping part 55 grasps the illuminance information of the grasping target space based on those pieces of information. The environmental information grasping part 55 grasps pieces of illuminance information of all the spaces 2 and stores the grasped pieces of illuminance information in the environmental information storage part 56. Similarly to the case of grasping the sound information, the environmental information grasping part 55 only needs to use at least a portion of the pieces of information described above.

### <Specific Examples of Processing of Outputting Environmental Information>

Next, the processing of outputting the environmental information is described taking specific examples.

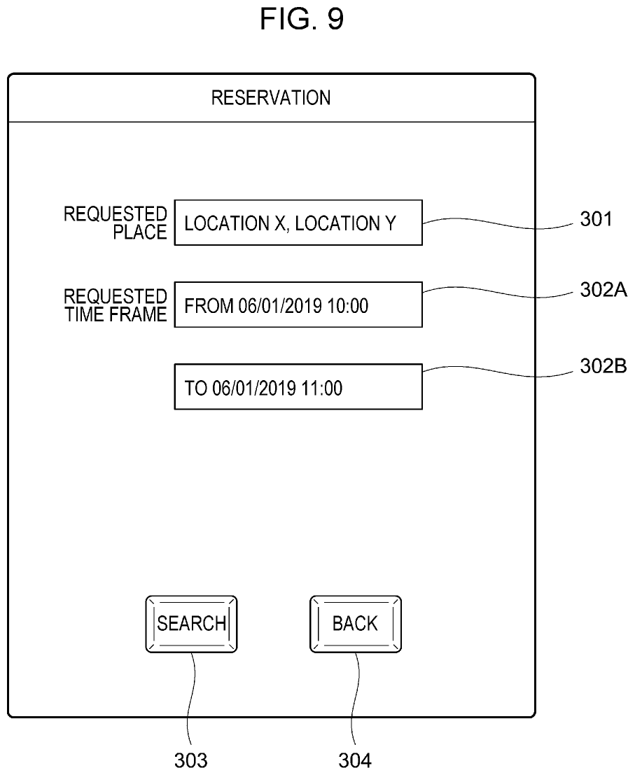

FIG. 9 illustrates an example of the reservation screen to be displayed on the display device 205 of the user terminal 4.

The reservation screen has an input field 301 for a requested place for a reservation, and input fields 302A and 302B for requested time frame for a reservation. The input field 302A is provided for a start point of the time frame and the input field 302B is provided for an end point of the time frame. In this example, the field 301 has an entry “LOCATION X, LOCATION Y”, the field 302A has an entry “06/01/2019 10:00”, and the field 302B has an entry “06/01/2019 11:00”.

Characters may be input to each field or selection may be made from among items prepared in advance.

At the lower end, the reservation screen has a “SEARCH” button 303 for use in a search for spaces 2 that satisfy conditions, and a “BACK” button 304 for use in cancellation of input information.

When the user selects the “SEARCH” button 303, the environmental information acquisition part 57 identifies spaces 2 that the user may want to reserve and a time frame requested by the user. This example demonstrates that a space 2 in the location X and a space 2 in the location Y are identified as the spaces 2 that the user may want to reserve and “06/01/2019 10:00-11:00” is identified as the time frame requested by the user.

Next, the environmental information acquisition part 57 acquires, from the environmental information storage part 56, pieces of environmental information related to the spaces 2 in the location X and the location Y for “06/01/2019 10:00-11:00”. The acquired pieces of environmental information are transmitted to the user terminal 4 and displayed on the display device 205 of the user terminal 4.

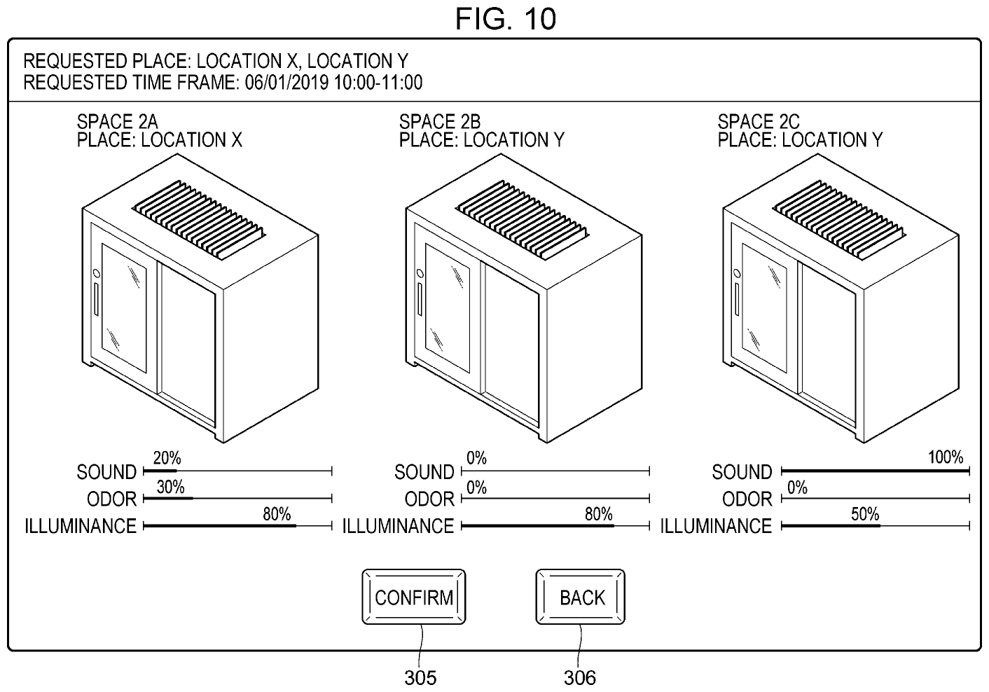

FIG. 10 illustrates an example of the environmental information to be displayed on the display device 205 of the user terminal 4. In the example illustrated in FIG. 10, a space 2A is shown as the space 2 in the location X and a space 2B and a space 2C are each shown as the space 2 in the location Y. The three spaces 2 are reservable for “06/01/2019 10:00-11:00” among the spaces 2 in the location X and the location Y. Sound information, odor information, and illuminance information are shown as the environmental information for each of the three spaces 2. The environmental information for the time frame “06/01/2019 10:00-11:00” is shown in this example.

In this example, the environmental information is represented by percentage. For example, in the case of sound information, the reference sound level is 100% and a percentage of the reference sound level is shown. In this case, a sound level exceeding the reference sound level is also represented by “100%”. The odor and the illuminance are similarly represented by percentage.

As the sound level decreases, the space 2 is more silent. As the odor level decreases, the odor in the space 2 is lighter. As the illuminance increases, the inside of the space 2 is brighter. In the example illustrated in FIG. 10, the space 2A is 20% for sound, 30% for odor, and 80% for illuminance.

The representation of the environmental information is not limited to the example described above. For example, the environmental information may be represented on a scale of 1 to 10 instead of percentage. Further, the sound level may be represented in “decibels (dB)” or the illuminance may be represented in “lux” to show a specific value.

Next, the user specifies one or a plurality of spaces 2 among the three spaces 2 and selects a “CONFIRM” button 305. Then, the space reservation part 59 reserves the specified space 2 for the time frame “06/01/2019 10:00-11:00”. At this time, the user may be prompted to input a purpose of use of the space 2. The space reservation part 59 stores the reservation information in the reservation history storage part 60. When the user selects a “BACK” button 306, the reservation screen is displayed again without confirming the reservation.

Thus, when the user reserves a space 2 (or when the user wants to reserve a space 2), environmental information is output to and displayed on the user terminal 4.

The user may specify the type of environmental information to be displayed on the screen.

For example, when the user selects the “SEARCH” button 303 in FIG. 9 and then specifies the type of environmental information on the screen, the environmental information output part 58 outputs the specified type of environmental information and the user terminal 4 displays the specified type of environmental information.

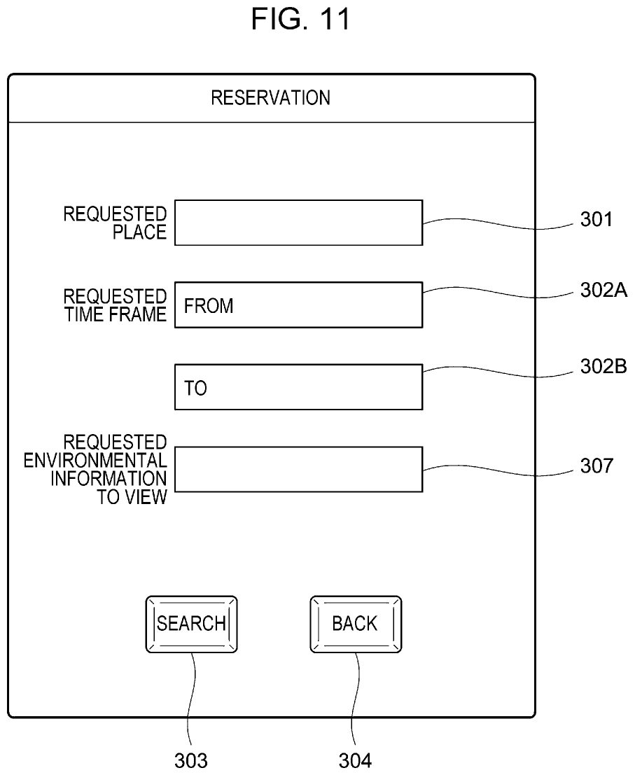

The user may specify, on the reservation screen, the type of environmental information to be displayed on the screen. FIG. 11 illustrates another example of the reservation screen. In the example illustrated in FIG. 11, a field 307 is added to the reservation screen illustrated in FIG. 9. The field 307 is an input field for environmental information to be displayed on the screen. For example, if the user inputs “sound” to the field 307 and selects the “SEARCH” button 303, sound information is displayed as environmental information related to the space 2. Characters may be input to the field 307 or selection may be made from among items prepared in advance.

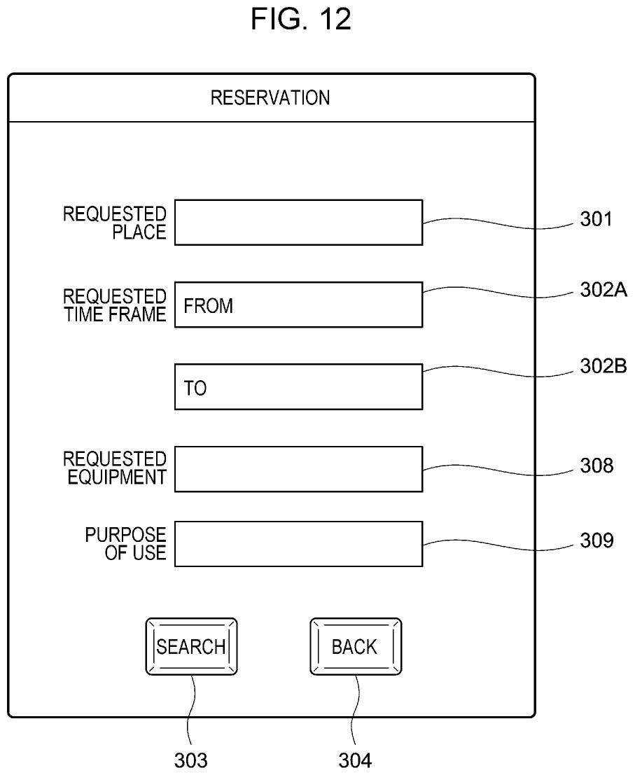

The user may input conditions other than a place condition and a time condition on the reservation screen. FIG. 12 illustrates another example of the reservation screen. In the example illustrated in FIG. 12, a field 308 and a field 309 are added to the reservation screen illustrated in FIG. 9. The field 308 is an input field for requested equipment. The field 309 is an input field for a purpose of use. For example, if the user inputs “PC” to the field 308 and “reading books” to the field 309 and selects the “SEARCH” button 303, the user terminal 4 displays spaces 2 that satisfy the place condition, the time condition, a condition that a PC is provided, and a condition that the spaces 2 are suited to “reading books”.

For example, the space 2 suited to “reading books” satisfies conditions that the sound is 30% or lower, the odor is 30% or lower, and the illuminance is 70% or higher. Thus, conditions on environmental information corresponding to each purpose of use are set in advance.

Characters may be input to the field 308 and the field 309 or selection may be made from among items prepared in advance.

The user may directly input requested conditions on environmental information instead of inputting the purpose of use. In this case, the user terminal 4 displays spaces 2 that satisfy the input conditions on environmental information. For example, if the user inputs “sound: 30% or lower”, the user terminal 4 displays spaces 2 that satisfy the condition that the sound is 30% or lower.

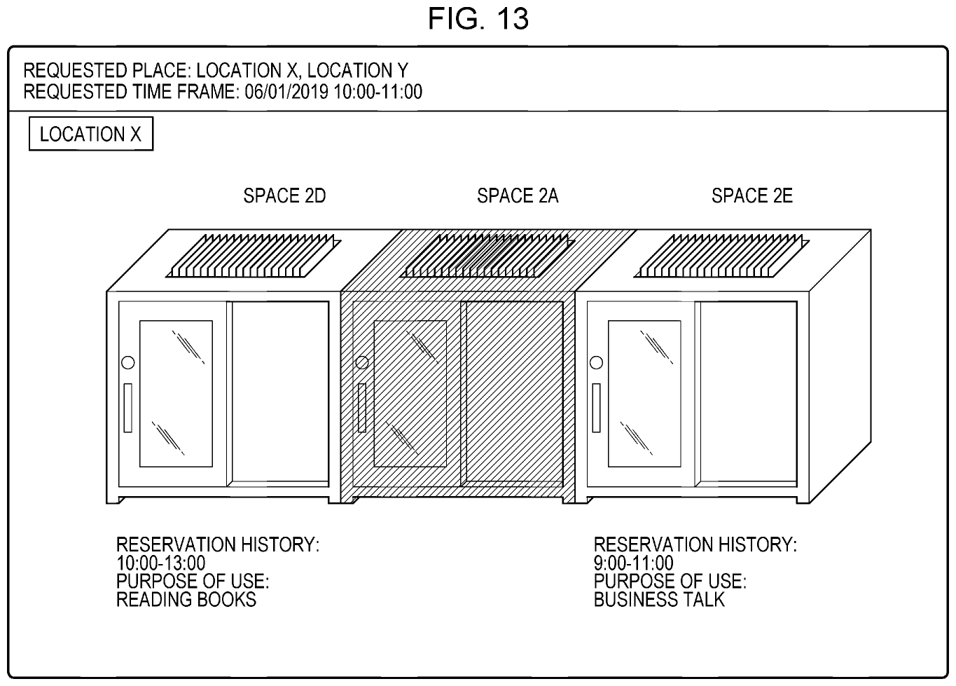

When the user specifies a space 2, information on other spaces 2 around the specified space 2 may be displayed. FIG. 13 illustrates an example of a screen showing information on the other spaces 2 around the space 2 specified by the user. This example demonstrates a case in which the user specifies the space 2A in FIG. 10. Specifically, a space 2D and a space 2E are located around the space 2A. Information about existing reservations for the space 2D and the space 2E whose time frame partially or entirely overlaps with the time frame requested by the user are shown to the user as information on each of the space 2D and the space 2E. For example, the space 2D has already been reserved for “06/01/2019 10:00-13:00” and the purpose of use is “reading books”. When the user reserves the space 2, the user may refer to not only the environmental information but also the information on other spaces 2 around the space 2.

<Processing to be Performed when Environmental Information has Changed>

Next, description is made of processing to be performed when environmental information for a space 2 reserved by the user has changed.

After the user reserves the space 2, environmental information for the reserved space 2 may change. Therefore, the environmental information output part 58 notifies the user when the environmental information for the reserved space 2 has changed. Specifically, the environmental information output part 58 notifies the user terminal 4 of the user who has made the reservation. If the user who has made the reservation does not use the space 2, the environmental information output part 58 may notify an actual user. Examples of details of the notification include the event of the change in the environmental information for the reserved space 2, the type of the changed environmental information, original information, changed information, and a change amount.

The environmental information output part 58 is used as an example of a notification unit.

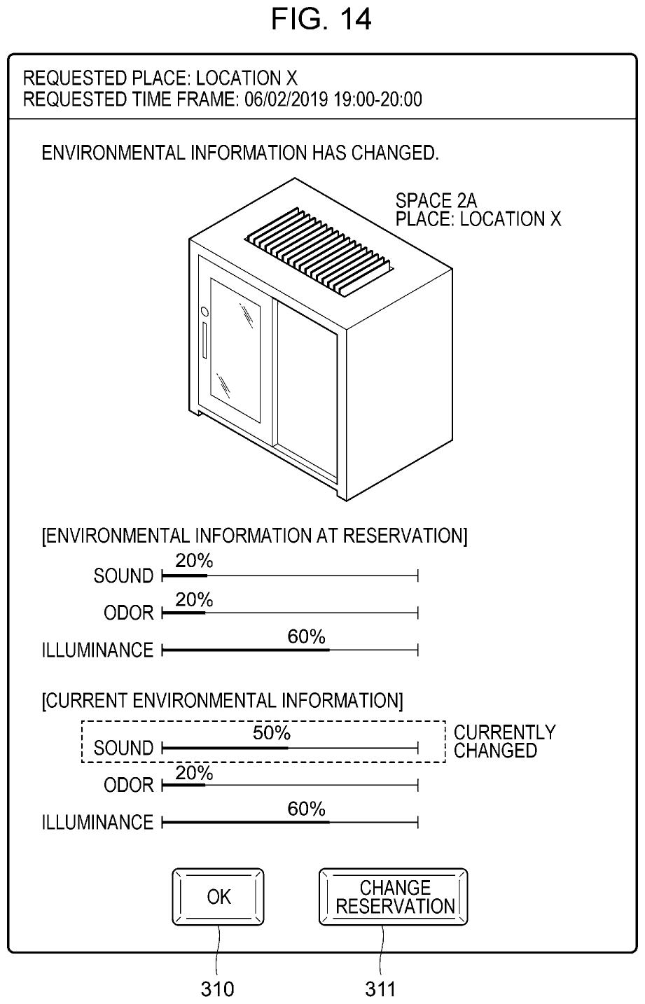

FIG. 14 illustrates an example of the notification of the change in the environmental information for the space 2 reserved by the user. This example demonstrates a case in which the user has reserved the space 2A in the location X for “06/02/2019 19:00-20:00” and then the environmental information for the space 2A related to the time frame changes. Specifically, when the space 2A was reserved by the user, the environmental information for the space 2A for the time frame indicated that expected levels of the sound, odor, illuminance of the space 2A during the time frame were 20%, 20%, and 60%, respectively. Then, the sound has changed from 20% to 50%, for example, because of another reservation newly made for the space 2A or a space 2 around the space 2A by a different user.

If the user selects an “OK” button 310, the state in which the space 2A is reserved is maintained. If the user selects a “CHANGE RESERVATION” button 311, the reservation screen is displayed. The user may change the reservation by inputting requested reservation conditions again on the reservation screen. The original reservation is not canceled when the user selects the “CHANGE RESERVATION” button 311 but is canceled when a new reservation is confirmed.

### (Example of Notification of Alternative Candidate Space 2)

When the environmental information for the space 2 reserved by the user has changed, the environmental information output part 58 may notify the user of another space 2 that is an alternative candidate for the space 2 reserved by the user.

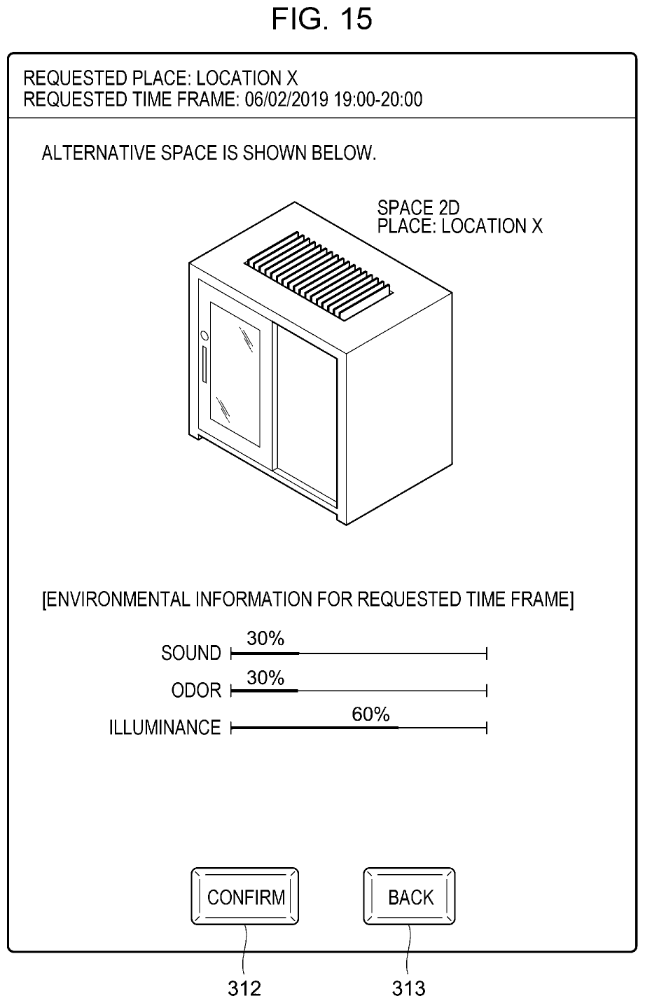

FIG. 15 illustrates an example of the notification of another space 2 that is an alternative candidate for the space 2 reserved by the user.

For example, if the user selects the “CHANGE RESERVATION” button 311 in FIG. 14, the environmental information output part 58 notifies the user of another space 2 that is an alternative candidate for the space 2A as illustrated in FIG. 15. For example, the other space 2 that is an alternative candidate for the space 2A shows environmental information similar to the environmental information for the space 2A. The environmental information for the space 2A is environmental information for the time frame reserved by the reservation made by the user (that is, requested time frame; 06/02/2019 19:00-20:00 in this example). For example, the environmental information similar to the environmental information for the space 2A is environmental information within a predetermined range with respect to the environmental information for the space 2A.

In the example illustrated in FIG. 14, the environmental information for the space 2A for the time frame reserved by the reservation made by the user (that is, 06/02/2019 19:00-20:00) indicates that the sound is 20%, the odor is 20%, and the illuminance is 60%. Therefore, the environmental information output part 58 notifies the user of a space 2 showing, for example, similar environmental information indicating that the sound is 0 to 30%, the odor is 0 to 30%, and the illuminance is 50 to 100%. In the example illustrated in FIG. 15, the user is notified of the space 2D currently showing environmental information indicating that expected levels of the sound is 30%, the odor is 30%, and the illuminance is 60% for the time frame reserved by the reservation (that is, 06/02/2019 19:00-20:00).

The user may decide whether to change the reservation after checking the environmental information for the space 2D. If the user selects a “CONFIRM” button 312, the space reservation part 59 reserves the space 2D and cancels the original reservation for the space 2A. If the user selects a “BACK” button 313, the screen illustrated in FIG. 14 or the reservation screen is displayed again without changing the reservation.

In the example illustrated in FIG. 15, the user is notified of the space 2D in the same location X as the space 2A as an alternative candidate for the space 2A. The user may be notified of a space 2 in a location different from the location X. For example, the user may be notified of a space 2 in a different location within a predetermined range from the location X, or a space 2 in a different location where a period required to reach the location X is equal to or shorter than a predetermined period. The user may specify in advance a condition on a location or area of a space 2 for notification.

### (Example of Notification of Alternative Candidate Time Frame)

When the environmental information for the space 2 reserved by the user has changed, the environmental information output part 58 may notify the user of other time frames that are an alternative candidate for the time frame for which the user has reserved the space 2.

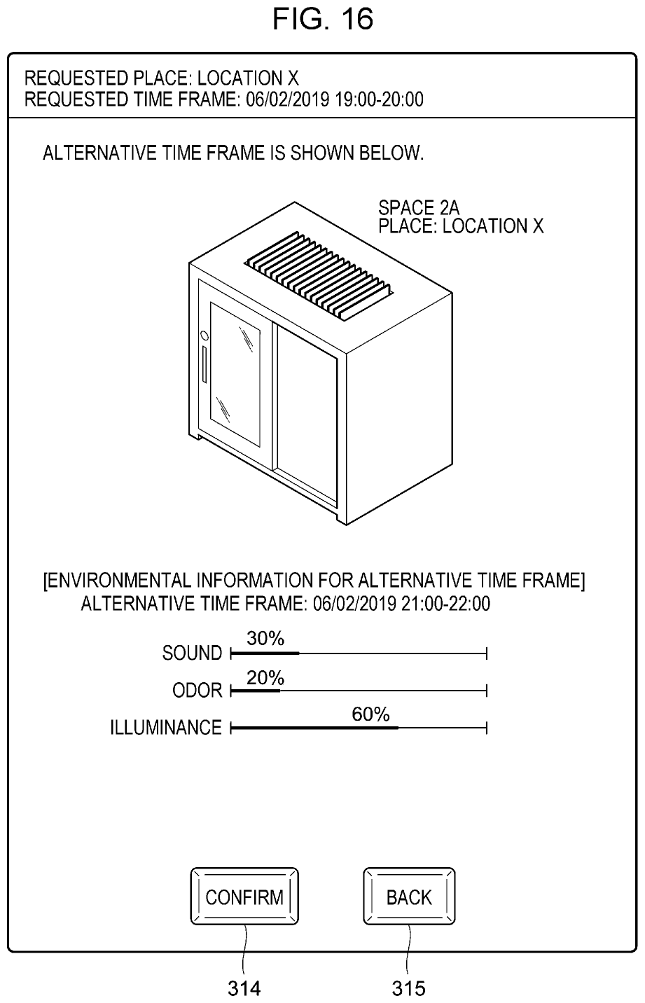

FIG. 16 illustrates an example of the notification of another time frame that is an alternative candidate for the time frame for which the user has reserved by his/her reservation.

For example, if the user selects the “CHANGE RESERVATION” button 311 in FIG. 14, the environmental information output part 58 notifies the user of another time frame that is an alternative candidate for the time frame for which the user has originally reserved, as illustrated in FIG. 16. Examples of time frames that are alternatives to the time frame for which the user has reserved the space 2 include an available time frame that has environmental information similar to the environmental information for the space 2 for the time frame that has originally been reserved by his/her reservation.

As described above, in the example illustrated in FIG. 14, the environmental information for the space 2A for the time frame that has been reserved by the reservation made by the user (that is, 06/02/2019 19:00-20:00) indicates that the sound is 20%, the odor is 20%, and the illuminance is 60%. Therefore, the environmental information output part 58 notifies the user of a time frame of the space 2A that has environmental information similar to the environmental information described above; for example, a time frame with environmental information that indicates the sound of 0 to 30%, the odor of 0 to 30%, and the illuminance of 50 to 100%. In the example illustrated in FIG. 16, environmental information for the space 2A for “06/02/2019 21:00-22:00” indicates that the sound is 30%, the odor is 20%, and the illuminance is 60%. This time frame for the space 2A has not yet been reserved and is still available. Therefore, the environmental information output part 58 notifies the user of this time frame.

The user may decide whether to change the reservation after checking the environmental information for the space 2A for the alternative time frame. If the user selects a “CONFIRM” button 314, the space reservation part 59 makes a reservation for the space 2A for the alternative time frame and cancels the original reservation. If the user selects a “BACK” button 315, the screen illustrated in FIG. 14 or the reservation screen is displayed again without changing the reservation.

In the example illustrated in FIG. 16, the user is notified of the information on the space 2A on the premise that the user probably wants to reserve the space 2A, not other spaces 2. However, the user may be notified of information on a space 2 other than the space 2A. For example, the user may be notified of an available time frame of another space 2 in the same location X as the space 2A, or an available time frame of a space 2 in a location different from the location X. The user may be allowed to specify in advance flexibility of alternative time frames of which the user wants to be notified (e.g., time frames within the same day as the original reservation) or may be allowed to specify a location condition and/or an area condition of alternative spaces 2 of which the user wants to be notified.

### (Notification Timing)

If the environmental information for the space 2 reserved by the user has changed, the user may be notified when a specific condition is satisfied instead of being notified on every occasion.

For example, the environmental information output part 58 notifies the user when the state indicated by the environmental information for the space 2 reserved by the user becomes larger than a predetermined reference. In the example illustrated in FIG. 10, the sound is 20% in the space 2A for the time frame reserved by the reservation (in this example, 06/01/2019 10:00-11:00). The environmental information output part 58 sets the reference to 30% and notifies the user when the sound exceeds 30% in the space 2A for the time frame reserved by the reservation. Similarly, references may be set for the odor and the illuminance. Further, the user may be notified when one of the plurality of types of environmental information exceeds the reference or when two or more types of environmental information exceed the references. In the case of illuminance, the user is notified when the illuminance falls below the predetermined reference.

For example, the environmental information output part 58 may notify the user when the change amount of the environmental information for the space 2 for the time frame reserved by the reservation exceeds a predetermined reference. For example, if a reference change amount of the sound is 10%, the user is notified when the change amount of the sound for the time frame reserved by the reservation exceeds 10%. If the change amount of the sound exceeds 10% but the sound level decreases, the notification need not be made because there is no problem when the space 2 becomes silent.

For example, the predetermined reference may be set by default in the space management server 5 or may be set by the user who reserves the space 2.

### (Processing of Changing Reservation)

When the environmental information for the space 2 reserved by the user has changed, the space reservation part 59 may change the user's reservation instead of notifying the user and accepting a change to the reservation from the user. Specifically, the space reservation part 59 may change the space 2 reserved by the reservation made by the user to another space 2 or may change the time frame reserved by the reservation made by the user to another time frame. In this case, the space reservation part 59 makes a change to another space 2 that is an alternative candidate for the space 2 reserved by the user or to another time frame that is an alternative candidate for the time frame that has been reserved by the reservation made by the user. After the reservation is changed, the user is notified of information indicating that the reservation is changed and information on the changed space 2 or the changed time frame.

As a condition for permitting the change, the user may be allowed to specify in advance a location condition or an area condition of the spaces 2 that can be alternative candidates. Similarly, the user may be allowed to specify in advance a condition for time frames that can be alternative candidates.

The space reservation part 59 is used as an example of a changing unit.

### <Processing of Selecting Space Based on Environmental Information>

In the examples described above, the user specifies the space 2 to be reserved based on the environmental information. In this exemplary embodiment, the space reservation part 59 may select, based on the environmental information, a space 2 to be reserved for use by the user who wants to reserve the space 2 from among the plurality of spaces 2.

For example, the user inputs reservation conditions on the reservation screen. For example, the user also inputs a purpose of use and requested conditions on environmental information. The space reservation part 59 selects, based on pieces of environmental information for the spaces 2, a space 2 that serves the user's purpose of use or a space 2 that satisfies the requested conditions on the environmental information.

The space reservation part 59 is used as an example of a selection unit.

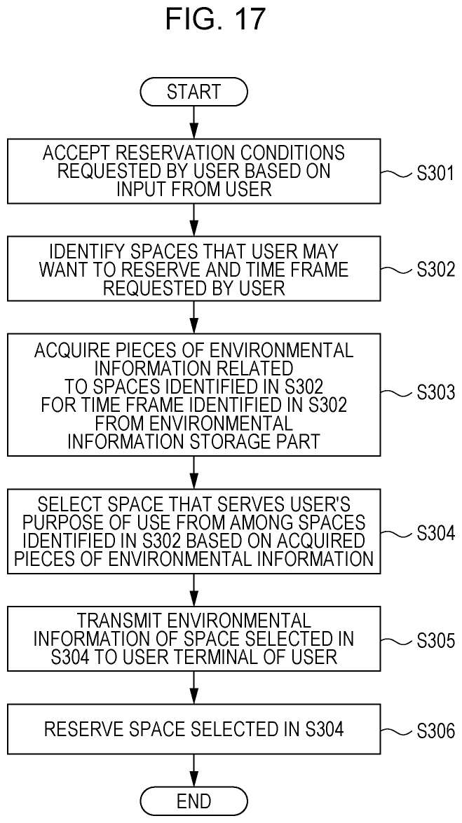

FIG. 17 is a flowchart illustrating an example of a procedure of processing of reserving a space 2 based on environmental information. Similarly to the processing illustrated in FIG. 8, the processing illustrated in FIG. 17 is performed, for example, at a timing when the user accesses the space management server 5 by using the user terminal 4 to input reservation conditions on the reservation screen. In this example, the state in which the reservation screen is displayed on the display device 205 of the user terminal 4 is described as an initial state. The example illustrated in FIG. 17 demonstrates a case in which the user inputs a purpose of use. The user may input requested conditions on environmental information.

When the reservation screen is displayed, the reservation acceptance part 51 accepts the reservation conditions requested by the user based on the input from the user (S301). The user also inputs the purpose of use in addition to the requested place and the requested time frame. Next, the environmental information acquisition part 57 identifies, based on the accepted reservation conditions, spaces 2 that the user may want to reserve and time frame requested by the user (S302).

Next, the environmental information acquisition part 57 acquires, from the environmental information storage part 56, pieces of environmental information related to the spaces 2 identified in S302 for the time frame identified in S302 (S303). Next, the space reservation part 59 selects a space 2 that serves the user's purpose of use from among the spaces 2 identified in S302 based on the acquired pieces of environmental information (S304).

Next, the environmental information output part 58 transmits environmental information for the space 2 selected in S304 to the user terminal 4 of the user (S305). When the user permits a reservation for the space 2 selected in S304, the space reservation part 59 reserves the space 2 selected in S304 (S306). Then, the processing flow is terminated. After S304, the space reservation part 59 may reserve the space 2 selected in S304 without the user's permission.

The processing of S304 is described taking specific examples.

For example, if the purpose of use by the user who will make a new reservation is “reading books”, the space reservation part 59 selects, from among the spaces 2 identified in S302, a space 2 that satisfies a condition that the sound is 30% or lower, the odor is 30% or lower, and the illuminance is 70% or higher for the time frame requested by the user. If a plurality of spaces 2 satisfy the condition, the space reservation part 59 selects a space 2 in accordance with a predetermined rule. For example, the predetermined rule is a rule that is based on the purpose of use. The purpose of use is at least one of the purpose of use by the user who will newly reserve a space 2 or a purpose of use by another user who has already reserved a space 2.

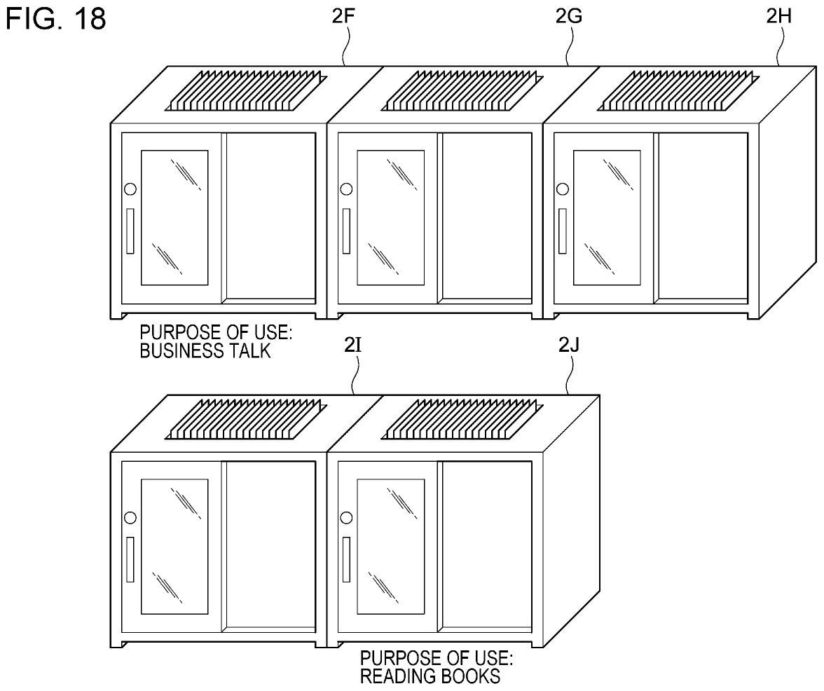

FIG. 18 illustrates an example of processing of selecting a space 2 in accordance with the rule that is based on the purpose of use. In this example, the place requested by the user is a location Z and the requested time frame are “06/03/2019 13:00-14:00”. As illustrated in FIG. 18, five spaces 2 (that is, spaces 2F to 2J) are present in the location Z. Among the spaces 2, the spaces 2G to 21 have not yet been reserved and are still available for the time frame requested by the user. The space 2F and the space 2J are not reservable because the spaces have already been reserved for the time frame requested by the user. The space 2F and the space 2J are reserved for the purposes of “business talk” and “reading books”, respectively.

If the purpose of use by the user who will make a new reservation is “business talk”, the space reservation part 59 selects, for example, a space 2 that satisfies a condition that the sound is 50% or lower, the odor is 50% or lower, and the illuminance is 70% or higher. In this example, the spaces 2G to 2I satisfy this condition. Therefore, the space reservation part 59 selects a space 2 from among the spaces 2G to 2I based on the purpose of use. For example, if the space 2I is reserved, voice in the business talk in the space 2I may be audible in the space 2J to hinder another user who is using the space 2J for “reading books”. Therefore, the space reservation part 59 selects, for example, the space 2G from among the spaces 2G to 2I. Specifically, the space reservation part 59 reserves the space 2G adjacent to the space 2F so that users having the same purpose of use are grouped.

The space reservation part 59 may select a space 2 to be reserved in consideration of the purpose of use by another user but without consideration of the purpose of use by the user who will newly reserve the space 2. For example, the space reservation part 59 selects the space 2G or the space 2H so as not to influence another user having a purpose of “reading books”.

Similarly, the space reservation part 59 may select a space to be reserved in consideration of the purpose of use by the user who will newly reserve the space 2 but without consideration of the purpose of use by another user. For example, the space reservation part 59 selects the space 2H located away from the reserved space 2F and the reserved space 2J so as not to influence other users because the purpose of use by the user who will make a new reservation is “business talk”.

The predetermined rule for selection of the space 2 is not limited to the rule that is based on the purpose of use. For example, the space reservation part 59 may preferentially select a space 2 having a longer idle time before a subsequent reservation in order to reduce influence of an odor to be generated by using the space 2 by the user. For example, idle times of the spaces 2G to 2I from the time frame of the reservation to be made by the user to the start of subsequent reservations are 1 hour, 10 hours, and 5 hours. In this case, the space reservation part 59 selects, from among the spaces 2G to 2I, the space 2H having the longest idle time before the subsequent reservation.

Next, the processing of S306 is described taking specific examples.

Similarly to the example illustrated in FIG. 18, the place requested by the user is the location Z and the requested time frame is “06/03/2019 13:00-14:00”. The space reservation part 59 selects the space 2G from among the spaces 2F to 2J in the location Z. The environmental information output part 58 transmits environmental information for the selected space 2G to the user terminal 4 of the user. Then, the display device 205 of the user terminal 4 displays the environmental information.

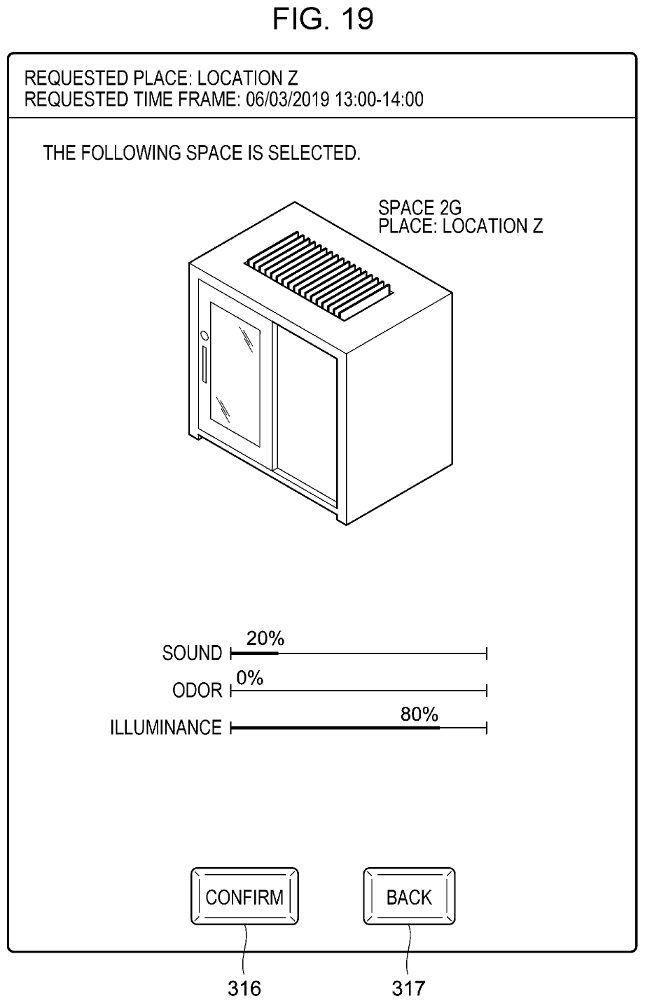

FIG. 19 illustrates an example of a screen showing information on the space 2 selected based on the environmental information. The example illustrated in FIG. 19 demonstrates the environmental information for the space 2G selected by the space reservation part 59. The environmental information is current environmental information for the space 2G for the time frame requested by the user (in this example, 06/03/2019 13:00-14:00). The user may decide whether to make a reservation after checking the environmental information for the space 2G. If the user selects a “CONFIRM” button 316, the space reservation part 59 reserves the space 2G. If the user selects a “BACK” button 317, the reservation screen is displayed again without making a reservation.

In the examples described above, the user is notified by displaying the environmental information and the like on the screen. In this exemplary embodiment, the user may be notified of the environmental information and the like by other methods. For example, the user may be notified of the environmental information and the like by voice.

The program that implements the exemplary embodiment of the present disclosure may be provided by a communication unit and may also be provided by being stored in a recording medium such as a CD-ROM.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing system, comprising:
an acquisition unit that acquires environmental information for a place registered in a reservation making system, the environment information being related to a time frame specified by a user; and
an output unit that outputs the environmental information acquired by the acquisition unit.

2. The information processing system according to claim 1, wherein the environmental information output by the output unit is environmental information of a type specified by the user among a plurality of types of environmental information.

3. The information processing system according to claim 1, wherein the environmental information is grasped based on at least one of (i) a reservation history of the place or (ii) a reservation history of a different place around the place.

4. The information processing system according to claim 3, wherein the reservation history of the different place comprises a purpose of use of the different place.

5. The information processing system according to claim 3, wherein the environmental information is grasped based on a usage history of an expected user expected to use the different place.

6. The information processing system according to claim 1, wherein the environmental information is grasped based on at least one of (i) information on equipment for the place or (ii) information on equipment for a different place around the place.

7. The information processing system according to claim 1, wherein the environmental information is grasped based on at least one of (i) information on a size of the place or (ii) information on a size of a different place around the place.

8. The information processing system according to claim 1, wherein the output unit outputs the environmental information when the user is making a reservation for the place for the specified time frame.

9. The information processing system according to claim 1, further comprising a notification unit that notifies the user if the environmental information for the place has changed after the user made a reservation for the place.

10. The information processing system according to claim 9, wherein the notification unit notifies the user of an alternative place to the place reserved by the reservation.

11. The information processing system according to claim 9, wherein the notification unit notifies the user of an alternative time frame to a time frame reserved by the reservation.

12. The information processing system according to claim 9, wherein the notification unit notifies the user when a state indicated by the environmental information becomes larger than a predetermined reference.

13. The information processing system according to claim 12, wherein the predetermined reference is set by the user.

14. The information processing system according to claim 1, further comprising a changing unit that, if the environmental information for the place has changed after a reservation for the place was made, changes the reservation.

15. The information processing system according to claim 14, wherein the changing unit changes the place reserved by the reservation.

16. The information processing system according to claim 14, wherein the changing unit changes a time frame reserved by the reservation.

17. The information processing system according to claim 1,
wherein the acquisition unit acquires environmental information for a plurality of places in the reservation making system, and
wherein the information processing system further comprises a selection unit that selects a place from among the plurality of places based on the environmental information about the plurality of places acquired by the acquisition unit.

18. The information processing system according to claim 17, wherein the selection of the place by the selecting unit is further based on at least one of (i) a purpose of use by the user or (ii) a purpose of use by another user who has already made a reservation using the reservation making system.

19. A non-transitory computer readable medium storing a program causing a computer to execute a process comprising:
acquiring environmental information for a place registered in a reservation making system, the environment information being related to a time frame specified by a user; and
outputting the acquired environmental information.

20. An information processing system, comprising:
acquisition means for acquiring environmental information for a place registered in a reservation making system, the environment information being related to a time frame specified by a user; and
output means for outputting the environmental information acquired by the acquisition means.
